(19) United States
(12) Patent Application Publication
(10) Pub. No.: US 2020/0104958 A1
(43) Pub. Date: Apr. 2, 2020

(54) Smart Contracts

(71) Applicant: ShelterZoom, New York, NY (US)

(72) Inventors: Chao Cheng-Shorland, New York, NY (US); Amir Homayoun Alishahi, Staten Island, NY (US); Dmitry Goroshevsky, Riga (LV)

(73) Assignee: ShelterZoom, New York, NY (US)

(21) Appl. No.: 16/588,867

(22) Filed: Sep. 30, 2019

Related U.S. Application Data
(60) Provisional application No. 62/738,848, filed on Sep. 28, 2018.

(51) Int. Cl. G06Q 50/18; G06F 3/0484

(52) U.S. Cl. CPC G06Q 50/188; G06Q 10/107; G06F 3/0484

(57) ABSTRACT

A system for smart contracts incorporates an Internet-connected server executing software providing a web presence with interactive interfaces, a data repository storing templates and completed contracts, a port to a blockchain service, a plurality of registered users each associated with a wallet, and a communication service for users. A registered user initiates a smart contract manually or by accessing a template from the data repository, the new contract associated with a Mithra token defining terms. With the issuing token in place, the issuer engages one or more counterparties to join the smart contract, a counterparty, by active engagement creating a counter token defining rights and obligations under the contract for the counterparty. Through the communication service the initiator and the counterparties negotiate contract terms to agreement, and the contract is signed and published to either a public store or a private store.

### CROSS-REFERENCE TO RELATED APPLICATIONS

The present application claims priority to provisional application 62/738,848, filed Sep. 28, 2018, and all disclosure of the parent document is incorporated at least by reference.

### BACKGROUND OF THE INVENTION

### 1. Field of the Invention

This present invention is in the technology of processes for negotiating and implementing agreements, contracts and transactions, and pertains more particularly to a new type of smart contracts and a system for integrating parties involved in such a contract type and its related transactions into a cooperative and secure system, and for distributing this new type of contracts across business and consumer network.

### 2. Description of Related Art

Legal contracts have had a slow evolution in the last few thousand years. The technology in producing, managing and executing contracts continues to be antiquated. The traditional contract system of creating, reviewing, negotiating, signing, executing, publishing and storing agreements and contracts is time-consuming and wasteful. Contracts presented in the structured data format, which is the majority of how so called “digital” contracts are being handled, makes contracts hard to track, verify, find terms within, audit or transfer. In addition this hinders advancement in the contract world by not being able to adequately apply technologies such as artificial intelligence and analytics.

In the 1990's, a new type of contract called smart contract was born. A smart contract is a computer protocol intended to digitally facilitate, verify, or enforce the negotiation or performance of a contract. Smart contracts allow performance of credible transactions without third parties. Many terms of a smart contract can be self-executing. For example, a smart contract specifies that a quantity of digital currency is to be transferred on the occurrence of a particular condition, a smart contract may be able to detect occurrence of a condition and transfer the digital currency when the occurrence is detected. These transactions are trackable and irreversible. In addition, cryptography used by smart contracts ensures security—an important requirement for contract management in a digitized world.

Smart contracts define rights and obligations of parties using a scripting language. One example scripting language for smart contracts is Solidity. Solidity is an object-oriented, high-level language that can control the behavior of accounts within the Ethereum blockchain. Solidity has been used to create smart contracts used to implement voting, crowdfunding, blind auctions, and multi-signature wallets.

Although smart contracts in the art undoubtedly provide some distinct benefits over traditional contract technology, they fall short by not being presented in a way that is human-readable. Human readability is a foremost attribute of any contract technology because a contract is a legally binding agreement which governs rights and duties of the parties to the agreement. Without human readability, applications of smart contracts is very limited.

There was an attempt to combine cryptography with contracts by Ian Grigg, a renowned financial cryptographer, when he invented the Ricardian Contract in 1996. The Ricardian contract is a method of recording a document as a contract at law, and linking it securely to other systems, such as accounting, for the contract as an issuance of value.

According to Grigg, “a Ricardian contract can be defined as a single document that is a) a contract offered by an issuer to holders, b) for a valuable right held by holders, and managed by the issuer, c) easily readable by people (like a contract on paper), d) readable by computer programs (parsable like a database), e) digitally signed, f) carries keys and server information, and g) is allied with a unique and secure identifier.”

There are important differences between Smart Contracts and Ricardian Contracts meaning that it's possible to implement a Ricardian contract as a smart contract, but not every Ricardian contract is a smart contract. Accordingly, not any smart contract is a Ricardian contract. Smart contracts refer to a type of digital agreement that has already been agreed upon and can be executed automatically. Meanwhile, a Ricardian contract follows the contract model which records the so-called ‘intentions’ and ‘actions’ of a particular contract, whether it has been executed or not. Using the hashes referring to external docs, Ricardian contracts can refer to code as well.

Benefits provided by Ricardian Contracts include security, transparency, efficiency and trust which is lacking in conventional written contracts, as well as human readability which is missing in smart contracts.

However, Ricardian Contract is unknown by the general public and has only been attempted by a small number of projects for implementation. One of the main challenges of the Ricardian Contract is its lack of usability, consumability and transferability. Like many great inventions, if there is no application, nor ecosystem built around them, they are very quickly forgotten or abandoned.

Therefore, what is clearly needed are:
A new type of contract that uses smart contract techniques, but is human-readable and consumable; and
A sophisticated, robust ecosystem that allows this new type of contract to be easily usable, consumable and transferable by users within the ecosystem.

### BRIEF SUMMARY OF THE INVENTION

In one embodiment of the invention, a system is provided for creating, negotiating, and ratifying smart contracts, the system comprising an Internet-connected server executing software (SW) on a processor, the SW providing a web presence with interactive interfaces, a data repository coupled to the server, storing user information, contract templates, and completed contracts, a port to a blockchain service, a registration interface for registering users, each user sat registration issued a digital blockchain wallet for either a personal account or a business account, and a communication service whereby registered users communicate. A registered user initiates a smart contract either by manually authoring the smart contract by an on-line editor, or by accessing a smart contract template from the data repository, the new contract, submitted to blockchain, being associated with a Mithra token defining all contract terms, and wherein, with the issuing token in place, the contract issuer engages one or more counterparties to join the smart contract, a counterparty, by active engagement creating a counter token defining rights and obligations under the contract for the counterparty, and, through the communication service the initiator and the counterparties negotiate contract terms to agreement, and the contract is signed and published to either a public store or a private store.

In one embodiment the contract is both human-readable and machine readable. Also, in one embodiment a counterparty is invited to join a contract by a direct email or text invitation from the initiator. Also, in one embodiment the issuer assigns user permissions to each invited counterparty, including but not limited to administration privileges, view only, edit and/or comment, or sign only. And in one embodiment, upon receiving the invitation via email or SMS, the invitee signs into the system, or registers, if a first-time user.

In one embodiment the initiator and a counterparty negotiate contract terms via a chat communication system, with terms codified in the respective Mithra tokens. Also, in one embodiment the initiator and the counterparty each are provided a human-readable version of the smart contract in a side-by-side presentation, such that each party may propose changes in terms, which may be reviewed and accepted or countered by the other party, until agreement is reached. In one embodiment the system further comprises a search function whereby users may search templates in the data repository to select a template for initiating a contract. In one embodiment the system further comprises a search function whereby a user may search published contracts and join a selected contract by submitting an offer or a proposal. In one embodiment, upon a user selecting a contract in a result of a search, a submission form is presented to the user, whereby the user may enter terms, which are entered in the smart contract, and a negotiation is initiated between the issuer and the submitting user. And in one embodiment the submitting user is issued a counter Mithra token defining rights and obligations for that user, who is now admitted to the negotiation process.

In another aspect of the invention a method for creating, negotiating, and ratifying smart contracts comprising initiating a smart contract either by manually authoring by an on-line editor operating by execution of software on a processor of an Internet-connected server, providing a system of interactive interfaces, or by accessing a smart contract template from a data repository coupled to the server, associating the new smart contract with a Mithra token defining all contract terms, by submitting the contract to a blockchain service, engaging a counterparty to join the smart contract, the counterparty issued a counter Mithra token defining rights and obligations for the counterparty, negotiating smart contract terms to agreement by the initiator and the counterparty using on-line communication service, and signing and publishing the smart contract to a public store or a private store.

In one embodiment the method comprises providing the contract as both human-readable and machine readable. Also, in one embodiment the method comprises inviting a counterparty to join a contract by a direct email or text invitation from the initiator. In one embodiment the method comprises assigning user permissions to each invited counterparty, including but not limited to administration privileges, view only, edit and/or comment, or sign only.

In one embodiment of the method, upon receiving the invitation via email or SMS, signing into the system or registering by the invitee. Also, in one embodiment the method comprises negotiating contract terms between the initiator and a counterparty via a chat communication system, with terms codified in the respective Mithra tokens. In one embodiment the method comprises providing in an interactive a human-readable version of the smart contract in a side-by-side presentation for the initiator and the counterparty, such that each party may propose changes in terms, which may be reviewed and accepted or countered by the other party, until agreement is reached.

In one embodiment the method further comprises a user searching by a search function for templates in the data repository to select a template for initiating a contract. In one embodiment the method further a user searching by a search function for published contracts and joining a selected contract by submitting an offer or a proposal. In one embodiment the method comprises resenting a submission form to a user whereby the user may enter terms, which are entered in the smart contract, and a negotiation is initiated between the issuer and the submitting user. And in one embodiment the method comprises issuing a counter Mithra token defining rights and obligations for the submitting user, who is now admitted to the negotiation process.

### BRIEF DESCRIPTION OF THE SEVERAL VIEWS OF THE DRAWINGS

FIG. 1 is a diagrammatical illustration of a Mithra Contract 101.

FIG. 2 is an architecture diagram illustrating at a high level, a system for a platform in an embodiment of the invention Mithra platform.

FIG. 3 illustrates one of many interactive interfaces which may be provided in the system domain in an embodiment of the invention.

FIG. 4 is a simplified example of an interactive interface in the system for creation, selection and editing of templates, in an embodiment of the invention.

FIG. 5 illustrates an interactive interface enabling users to search for contracts, templates and open contracts, stored in various collections in the system, in an embodiment of the invention.

FIG. 6 illustrates an exemplary Project Summary Dashboard for a user in an embodiment of the invention.

FIG. 7 is an example of a Project Detail Dashboard in an embodiment of the invention.

FIG. 8 illustrates a window that a user may invoke to invite others to join a contract in an embodiment of the invention.

FIG. 9 illustrates result of a search for contracts in an embodiment of the invention.

FIG. 10 illustrates an interface enabling a user to submit an offer and join a contract in an embodiment of the invention.

FIG. 11 illustrates a side-by-side display of a same contract to two participants in an embodiment of the invention.

### DETAILED DESCRIPTION OF THE INVENTION

The present invention comprises two major components:

1. A new type of smart contract referred to herein as a Mithra Contract; and

2. A system for integrating parties involved in Mithra Contract and its related transactions into a cooperative and secure system, and for distributing this new type of contracts across business and consumer network.

### Mithra Contract

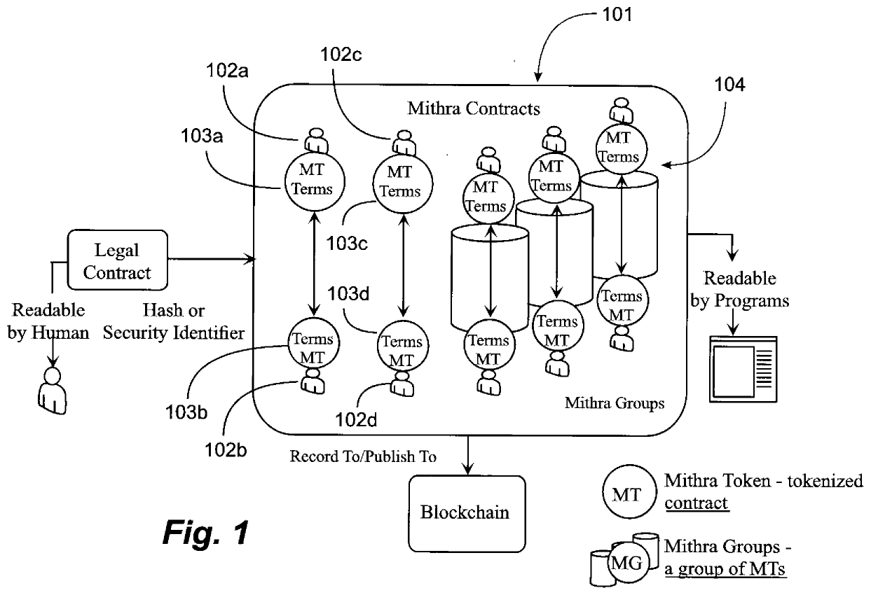

FIG. 1 is a diagrammatical illustration of a Mithra Contract 101. A Mithra Contract (MC) is a new type of smart contract that allows users to create, negotiate, and ratify contracts that both human-readable and machine-readable, legally binding, machine executable and human shareable, but are further tokenized to enable transferability, trackability, tradeability and portability.

Unlike a Ricardian Contract, the human readability of a Mithra Contract is achieved by making a human-readable representation on the World Wide Web (WWW) of a MC's underlying smart contract. The MC's underlying smart contract is accessible through a link. The link is shown in FIG. 1 on the left of the figure. The links are unique sharable addresses and may be human-readable. The human-readable addresses can resolve to a smart contract address that identifies a location on a distributed ledger or blockchain. In contrast to the human-readable address, the contract address may be a long alphanumeric or hexadecimal number. In an example, the human-readable address may identify a location on the WWW of the human-readable version of the MC, for example, by including a Uniform Resource Locator.

The human-readable address may resolve to the smart contract address using the Ethereum Blockchain standard EIP/ERC181.8. Similarly, a reverse resolution enabling a lookup of the human-readable address to the smart contract address may be possible using the EIP/ERC181.8 standard. In this way, with a Mithra Contract, an authorized user is able to read a representation of a smart contract already presented on the blockchain in a human-readable form by opening it in a compatible editor. Mithra Contract further tokenizes a contract by representing each term or set of terms defined in a contract between contractual parties on a special form of token called Mithra Token (MT). The MT may specify both a section of code defining terms for a smart contract and human readable text describing the terms. Each party involved in a contract, not only contractual parties, but also legal representatives, power of attorney, agents and other authorized parties, will hold a Mithra Token with its respective obligations, permissions and rights. In FIG. 1 a registered member 102a owns a MT 103a that defines certain terms associated with that person. Another member 102b owns a MT 103b that defines certain permissions and rights. The arrow joining the two illustrates that the permissions and rights are associated. As a simple example, MT 103a may define a right for member 102a to collect a monthly rent from member 1102b, so MT 103b shall define terms of obligation to pay the monthly rent due member 102a by MT 103a.

A complete set of terms, represented by Mithra Tokens, is grouped together to form a Mithra Group (MG). Therefore, a Mithra Contract can comprise an infinite number of Mithra Groups and each Group can comprise an infinite number of Mithra Tokens until it reaches finality triggered by either a signature from all required parties or when contract terms match between a single pair of tokens in the group. Since each MT is a set of rights and obligations, it represents an asset that can have a value and thus the owner of a MT can charge or pay money for changing the MT's ownership. In FIG. 1 a number of Mithra Groups 104 are illustrated. It should be noted that the members and tokens represented by 102x and 103x are not necessarily separate from the groups but are grouped together.

To further define, a contract governs the rights and obligations of the parties to the agreement. A right on one side of a contract is equivalent to a correlative obligation on the other side, and vice versa. Therefore, terms represented by a Mithra Token can sometimes be further categorized as a right, obligation or other. This is particularly useful when a Mithra Token carries an intrinsic value for which the rights can be transferred or monetized. A Mithra Contract comprises the entire set of negotiated right and obligations represented by the tokens and associated with persons.

Consequently, the Mithra Token becomes a fully tradable token on its own, that can be transferred to another party along with all its rights and obligations regarding the Mithra Group in the Mithra Contract.

Mithra Contracts offer various technical features that can improve the distributed computer platform on which they operate. For example, the way that human readable versions are linked to smart contracts on the Ethereum blockchain allow for more efficient lookups between the two. Instead of having to cross-reference a variety of different databases, a resolver is employed that require secure computing resources. In another example, by grouping contract terms into tokens, memory may be used more efficiently. Instead of having common terms repeated many times over many different contracts, the tokenization allows for centralization and reuse of common terms. In this way, Mithra Contracts provide various technical and technological improvements.

### Mithra Platform—An Ecosystem for Mithra Contracts

The Mithra platform is made up of a range of novel technology components that are integrated and highly consumable by individuals and businesses alike creating an ecosystem for Mithra Contracts. The Mithra platform constitutes a specific application that allows for generation of the smart contract and corresponding human readable form of the smart contract.

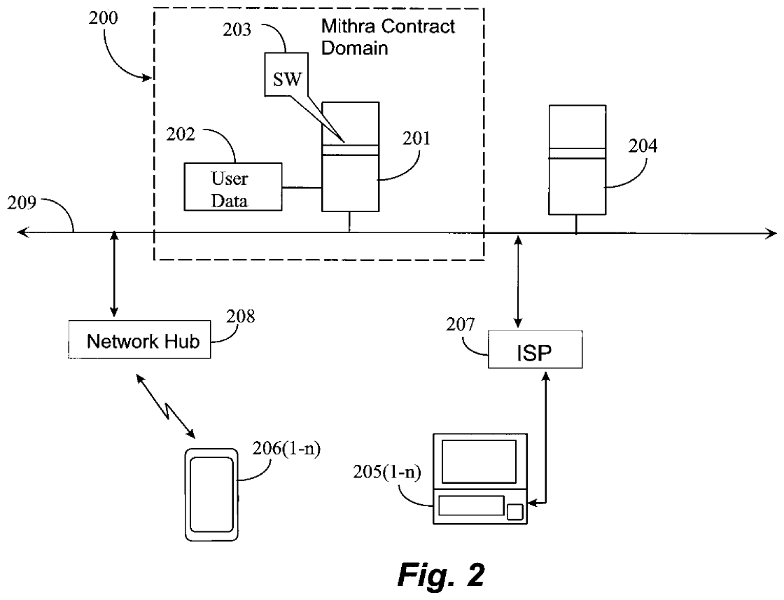

FIG. 2 is an architecture diagram illustrating at a high-level system for the Mithra platform. Line 209 represents the well-known Internet network, including all interconnected networks and sub-networks. A Mithra domain 200 comprises a server 201 executing software 203 on a processor. Software 203 provides a web site as well as a user Dashboard having a plurality of interactive interfaces for users to interact with the system. A data repository 202 provides storage for user data and contacts, and other data storage as needed by server 201. A skilled person will be aware that there may be a plurality of servers and data repositories, and system intelligence may be distributed in many ways. The simplified architecture illustrated is deemed to be adequate to describe functionality of the systems of the invention.

A third-party server 204 is meant to represent a substantial plurality of servers and domains in the Internet network with which Mithra domain 200 may interact is performance of services for registered members. One such service may be a connection to a blockchain service, such as Ethereum™, for example.

Users 205(1-n) are users who connect with Mithra domain 200 via computers, such as pad devices, laptop computers, tower systems, and integrated systems having internal LANs. Connection is typically through one or another sort of Internet Service Provider (ISP) 207. Users 206(1-n) represent users connecting through mobile devices, such as smartphones and the like, via wireless networks, through for example network hubs 208.

In one embodiment, Mithra domain 200 is configured to enable users, through computerized devices executing a web browser, to interact with Mithra domain 200. In an alternative embodiment, each user platform may download and execute an application that communicates with a compatible application executing at Mithra domain 200.

Exemplary interactive interfaces are described below for a variety of purposes.

### User Wallet and Account Management

### User Wallet Management

To participate in the system, a user needs to first register or sign in by either importing a seed phrase assigned to the user's existing wallet or having a new Blockchain wallet created by the system. The system assigns a highly secure private key (seed phrase) to a new wallet address enabling the participation and accessing the new wallet. The system also provides helpful tips on how to safely guide the private key.

A user wallet will be used for two main purposes:
Managing system access as described above; and
Managing utility tokens required for system usage such as purchasing more tokens, transferring tokens to another wallet, or making a payment.

### User, Account and Wallet Management

Due to the enterprise nature of the system and its business and consumer target market, the system must overcome the existing distributed ledger model which lacks meaningful structure and permission management to carry out agreement, contract and transaction processes. For example, as a business user, contracts and transactions created by the user belongs to his respective organization, not to him personally.

Therefore, in one embodiment of the system, two user account types are provided-one business account, one personal account.

### Business Account Vs Personal Account

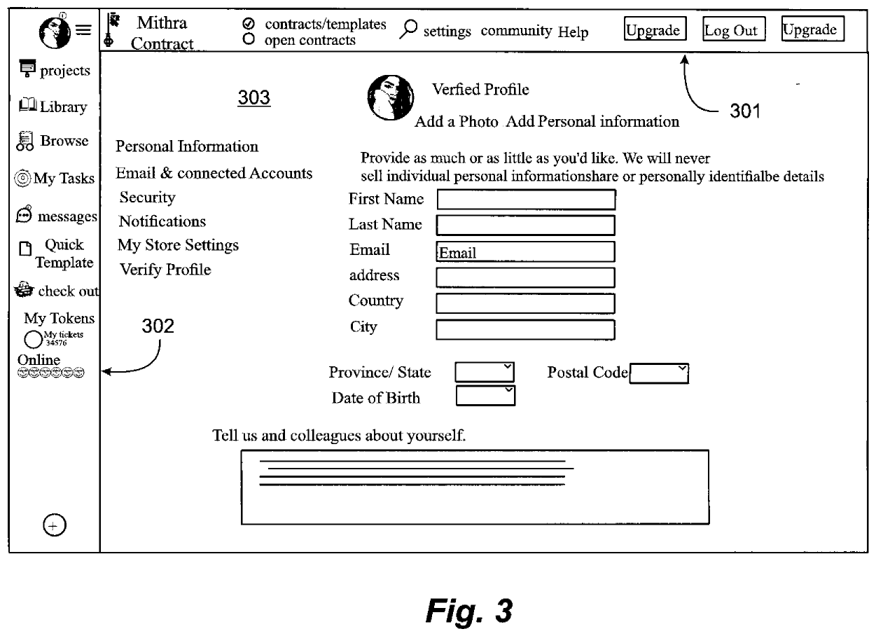

FIG. 3 illustrates one of many interactive interfaces which may be provided by SW 203 executing on server 201 in Mithra domain 200. The service provided by the interactive interface illustrated by FIG. 3 is for registration of new members, and in some cases, editing of registration information. The registration interface has been selected in this example, but a variety of interfaces for different purposes may be selected in a menu column 302 seen down the left side of the registration interface. This menu column remains for essentially all interfaces that may be accessed by users, allowing the users to easily navigate from one interface to another. A command line 301 provides links to various other functions enabled by SW 203 as seen in FIG. 2. The skilled person will understand that SW 203 may be a wide variety of programs and executable code providing many different functions and executing on many different platforms.

The interface shown is operable for a new user to register, and to provide necessary information to the system to instantiate the registering person or business as a registered user. Input fields are provided in area 303 of the interface for such as name, address, email, and so on as is common in this sort of interface. Other functionality related to registration is provided by a menu list at the near left in area 303, including, for example, personal information, Email and connected accounts, Security, Notifications, and so on. These are links that redirect the user to other interfaces.

At time of registration to the Mithra ecosystem, a user is asked to create a business account or a personal account. If a new user chooses a business account, the system will issue a new wallet for the user instead of allowing the user to use an existing wallet even though it may be compatible. The purpose is that a business account associated wallet will remain within the business and will be used solely for the business. An individual can hold two system accounts with two separate wallets, one for his business and one for his personal use.

Business and personal account types share several common functions, and both contain:
User information
Emails and connected accounts like LinkedIn or Facebook
Security setting
Proof of Identity or KYC (Know Your Customer)
Notification setting
Preference, e.g., Project View, Project Sorted By
Wallet information such as wallet address
   The following setting differentiates a business account from a personal account:
   Account Type—Business Vs. Personal:

For a business account, a few additional fields will be required, such as User role, which may be Administrator, user or other roles required. Also, an Organization Unit Identifier (searchable from a registered organization list)—users from the same organization should have the same value in this field.

The first person to create a business account for a specific organization fills in the details of an organization such as its name, address, contact details and industry. This person is automatically granted an Administrator role. In addition, the system will automatically generate an organization unit identifier.

### Business Admin User Dashboard

An admin user is given a purposeful admin dashboard to perform a set of operations. This dashboard is a set of interactive interfaces each providing as needed input fields and links to other interfaces, the functionality of which is described herein, without explicitly illustrating individual fields and links in the interfaces.
Invite a new user: invite a new user from the same organization unit into the system via an email and/or SMS invite. A new user must create a new wallet on the platform instead of re-using an existing compatible wallet. The default role for a new user is set to “User”, but the admin user can choose another role at the time of invitation.
Change a user role: upgrade or downgrade a user role.
Revoke a user: when a user leaves an organization or is no longer required to hold a system license, an admin user can revoke a user's account and the user access to the wallet associated with the revoked account.
Recover a user: if a user access is accidentally revoked or a user is required to resume the system use, an admin user can recover the account and the user access to the wallet.

The system does not allow a wallet access associated with a revoked account. However, there is a possibility that a revoked user will try to port the wallet to another compatible blockchain network to use. A global system switch is in place to ensure a disabled business wallet does not regain access to any Mithra system associated data.

### Template Management

Templates in Mithra Contracts are, as the term implies, structured digital documents that define the nature of a term, a contract or a project. The templates may have fixed statements, and variables that can be adjusted. The variables allow for templates to be adapted to a particular situation and may provide flexibility for parties to negotiate the term.

As an example, to create a contract for the sale of a business building, the nature of the contract is that there will be certain fixed language, and a number of variables. The facts that the transaction represented by the sale of the building is a sale, with rights transferring from one party or organization to another party or organization is fixed. Who the parties to the transaction are, the sale price, the means and terms of payment, these are all variables to be negotiated and finalized in the evolution of the contract. But once such a contract is finalized, a template may be created that defines the fixed elements and the location of the variable elements. One who develops such a contract may own rights in the template and may charge for use of the template by another to create a contract for sale of a different building, in which the variables to be negotiated may be the same.

The Mithra ecosystem is heavily driven by template usage. There are three hierarchical levels of templates available, namely term template, contract template and project template.

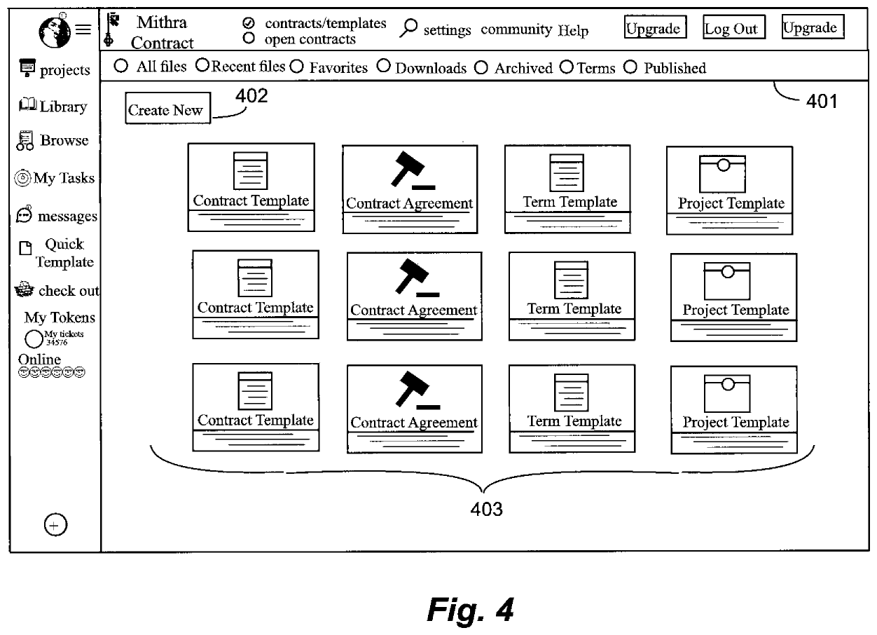

By providing templates, embodiments may offer technical advantages in terms of memory and processing power usage. Allowing frequently used contract terms to be reused in templates may use memory more efficiently than repeating or having to re-generate the same language each time. FIG. 4 is a simplified example of an interactive interface in the Mithra system for creation, selection and editing of templates. The dashboard links shown as element 302 in FIG. 3 are, of course, present as they are in essentially in all interactive interfaces p-resented to users in the system. A command line 401 provides active links for navigating to alternative collections of templates. A “Create New” link 402 navigates to interactive interfaces enabling a user to create a new template. A collection 403 of existing templates of various sorts and for various uses are displayed.

Each project template is made up of one or multiple contract templates, which is made up of one or multiple term templates.

Templates can be defined within a hierarchy:
Generic templates
Industry-specific templates, e.g., Medical, Oil & Gas, Real Estate
Geographic-specific template, e.g., California, Singapore, London
Organization-specific template, e.g., a government department, an association, a private company
Individual-specific template

All templates are reusable, searchable and analyzable. Breaking templates down to the term level enables digital terms to be reused in multiple contracts and contract templates and makes templates searchable via keywords and/or other search criteria. More importantly, terms may be analyzed and may become valuable to contract users. For example, the system now has a way to analyze how many times one particular term has been used across the ecosystem. This enables contract users to gain insights such as if a term is a standard term used by many users, or a customized term to which they need to pay a special attention. The system marks a green traffic light for standard terms and a red light for terms that require careful review.

A template can be created via a user's library by simply adding a new template. Alternatively, it can be generated via the saving-a-template feature when a project, contract or term is created or updated.

All templates will appear in a user's library dashboard which enables a user to organize in various categories such as Recent Files, Favorites, Downloads, Archive and Published.

A template can be saved in a user's library on the dashboard, and organized in various categories such as Recent Files, Favorites, Downloads, Archive and Published.

A template owner can choose to either publish a template to a private setting or to a public store. Once it is made available to the public, the template becomes searchable in the template marketplace on the Mithra platform, downloadable and usable by other users. The template owner can decide whether or not a payment is required for a public user to download his template. The system facilitates a payment process for a template purchase.

A user can choose any appropriate payment method. On the Mithra platform, ShelterZoom Mithra Coin (SMC) utility tokens are typically used for a template trade. Therefore, SMCs will be paid from a buyer's wallet to a template seller's wallet.

In a scenario where a template is published to a private store, all users who have access to the private store can also download and use the template. For example, it is common for a company or an association to publish a template for their respective employees or members to use their organization standard templates. This will significantly reduce template replication across an organization. Once a digital template is created once, all authorized users can download from the same source without re-creating it by each individual.

Those privately published templates are often free for members to use but can also require a payment from their template users.

A template user is also able to subscribe to template notifications. For instance, when a new template is made available to their subscribed industry or category, or a new version is published for a template the user has downloaded, she will receive a system notification. In addition, a contract template is one of the main starting points to initiate a contract creation.

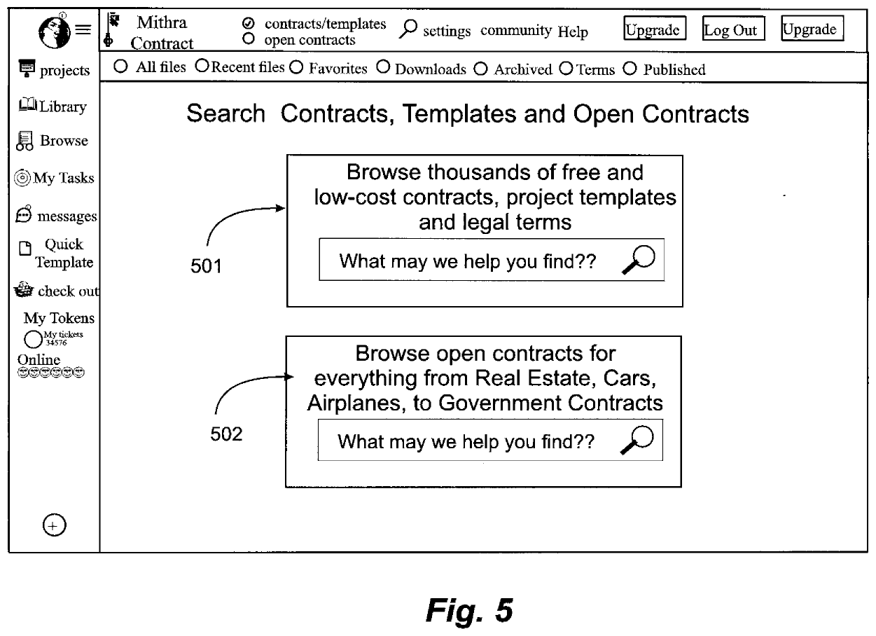

FIG. 5 illustrates an interface enabling users to search for contracts, templates and open contracts, stored in various collections in the system. The usual command lines for Mithra dashboard are always evident, and this interface provides a query field 501 for a user to input queries to find low-cost contracts, project and legal term templates. Additionally, a second query field 502 enables users to search for and find existing contracts for just about anything, which a user may use as is, or may edit to produce a proprietary contract, which may then be saved as a template.

### Project (Transaction) Management

Project Management, sometimes referred as Transaction Management in the system, is the starting point of a Mithra Contract creation. A project can be any type of projects or transactions such as a procurement project, a real estate transaction, a financial transaction or a supply chain project.

### Project Summary Dashboard

From the Project Summary dashboard, a user can:
Gain insights of his recent projects, new messages and aggregated status summary at one quick glance;
View key information on each project such as project name, start date, status and profile images of project participants;
Create a new project (transaction);
Select an existing project;
Sort the project list by date, status, user, or other sorting orders available; and
Search projects by defined search criteria.
   Projects are presented in either a card view or a line view to cater for the user's preference.

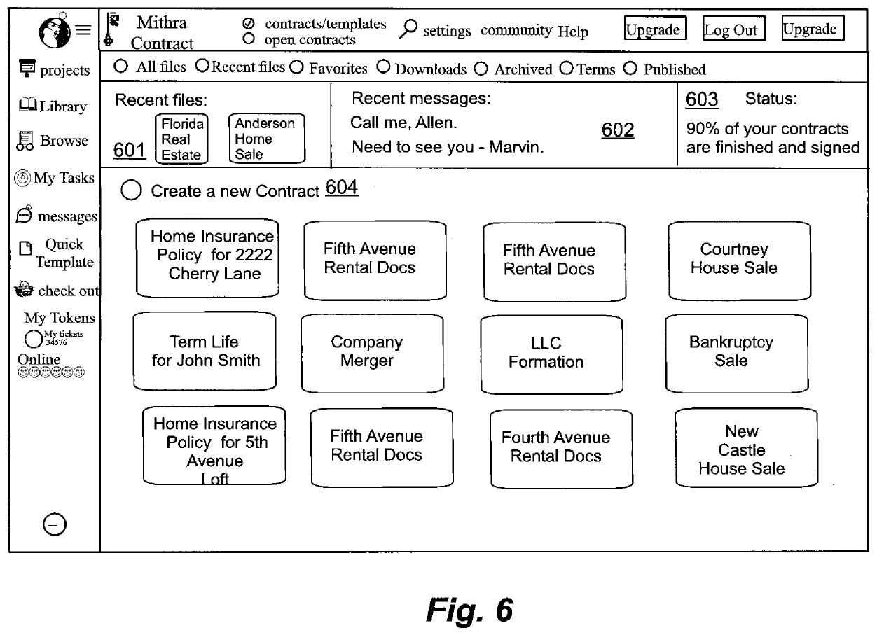

FIG. 6 illustrates an exemplary Project Summary Dashboard for a user, formatted in Card View. Recently accessed files may be selected in an area 601. Recent messages may be visited and replied to in an area 602. A status is presented in area 603. The skilled person will understand that the interface in FIG. 6 is exemplary, and much functionality may be missing, as the figure requires certain standards for font size, etc.

All projects in a user's wallet are presented in this dashboard in Card View, in area 604, with each project in a small, card-size icon. In this example only a title is shown, but in some embodiments considerably more information, status, such as signed or not, dates, and the like, may be displayed as well.

Each icon is a link to the project indicated, and selection of one project redirects the user to other interfaces where the project may be further managed, as is described further below.

In an alternative embodiment the Project Summary Dashboard is presented in a Line View, with each project represented in a line rather than as a card. The functionality is the same.

### Project Detail Dashboard

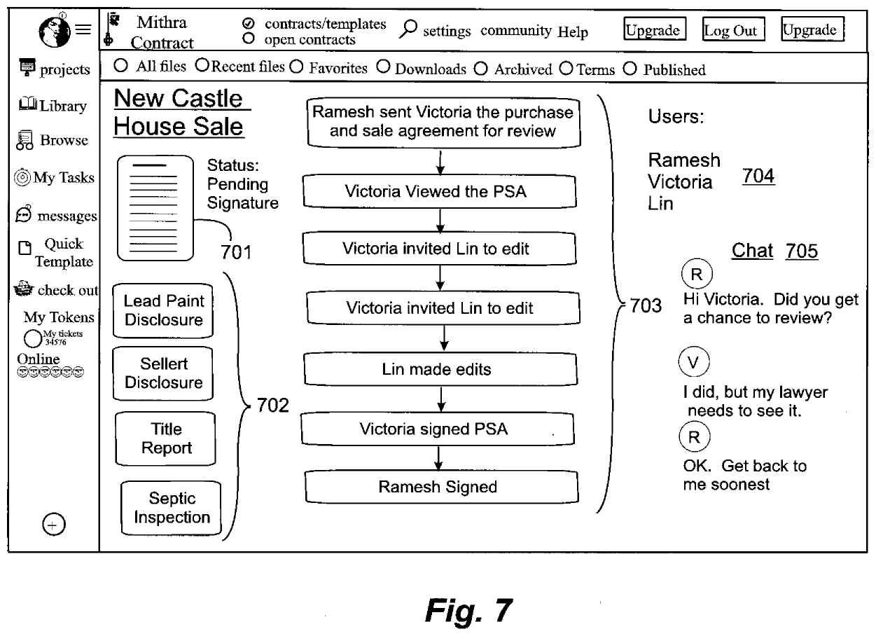

Once a user selects an existing project, the user is redirected to a Project Detail dashboard. FIG. 7 is an example of a Project Detail Dashboard in an embodiment of the invention. This dashboard is divided into five main sections as follows:
Documents—all contracts and documents associated with the project are displayed in either a card view or a line view, at area 702, which is sortable and searchable.
Chosen Contract—a quick overview of a chosen contract 701
Workflow—a detailed workflow 703 for a chosen contract which contains all historical versions of the contract, as well as actions and participants associated with each version. The user can click on any version in the workflow to drill down to the contract detail page.
Users—a list of participants of a chosen contract in area 704
Chat—a chat section 705 to facilitate communication between participants who have permission to chat, and view history of the chat. A contract issuer defines permissions for user chat privilege, e.g., a seller and a buyer can directly chat if there is no agent in between but cannot chat directly if there is an agent appointed. Please refer to the Chat section in the later part of the document for more advanced features.

This dashboard is also used to initiation the creation of a new contract for a new project or an existing project.

### Contract Management

Contract management is a critically important feature of the invention in many embodiments.

### Creating a Contract—Issuing a Mithra Token

The contract process starts with the creation of a new contract based on either a pre-defined template or an entirely new contract. In the latter scenario, the contract author can use an inline editor to add terms manually one by one, or to find appropriate terms via searching a term template library and inserting them into a contract. Either way, when a user selects a pre-defined template or finds appropriate terms using the term template library, the chosen template is retrieved and assembled into the MC. Then, the user may define any variables within the templates or term templates.

Upon completion, the contract author can submit the contract to blockchain which in turn generates a smart contract with an issuing token (Mithra Token) that carries all the defined terms.

Publishing a Contract—Public Store Vs. Private Store

The contract issuer can choose to publish a contract either to a public store or to a private store. Contracts published to a public store are available at the global search area so that everyone can browse those contracts and have an opportunity to join a contract. Contracts held in a private store are not searchable by the public. Users can only join a contract by invitation.

### Joining a Contract—Creating a Counter Mithra Token

With the issuing token in place, the contract issuer can now engage a counterparty or multiple counterparties to join the contract according to the publication method:

1. Invite a counterparty via a private invite
The issuer can invite one or many parties to join his contract, and assign different user permission for each invitee, e.g., admin, view, edit and/or comment, or sign only.
Upon receiving an invitation via email or SMS, the invitee can sign into the system, or register if he is the first-time user.
The invitee can formally join the contract and create a counter Mithra Token by either signing the contract, or submitting an offer, or directly counter terms on a contract.

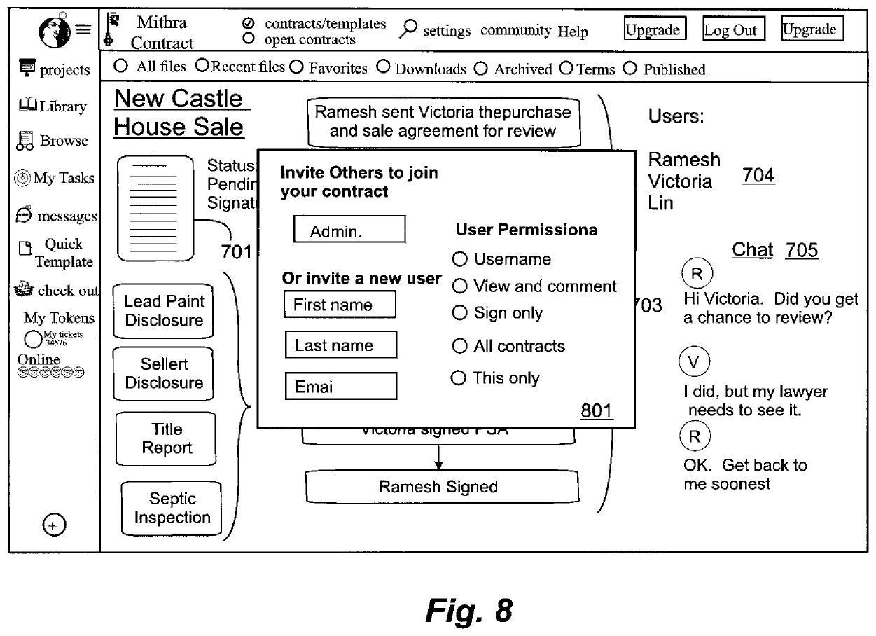

FIG. 8 illustrates a window 801 that a user may invoke to invite others to join a contract. If the “other” to be invited he or she will have a username, and a profile with contact information. The inviting user may select User Permissions as shown in window 801, and the invited user will receive a communication, such as an email, according to configuration, with the invitation. A new user may be invited as well, and upon registering in the process will become a registered user.

### 2. Join via Contract Marketplace

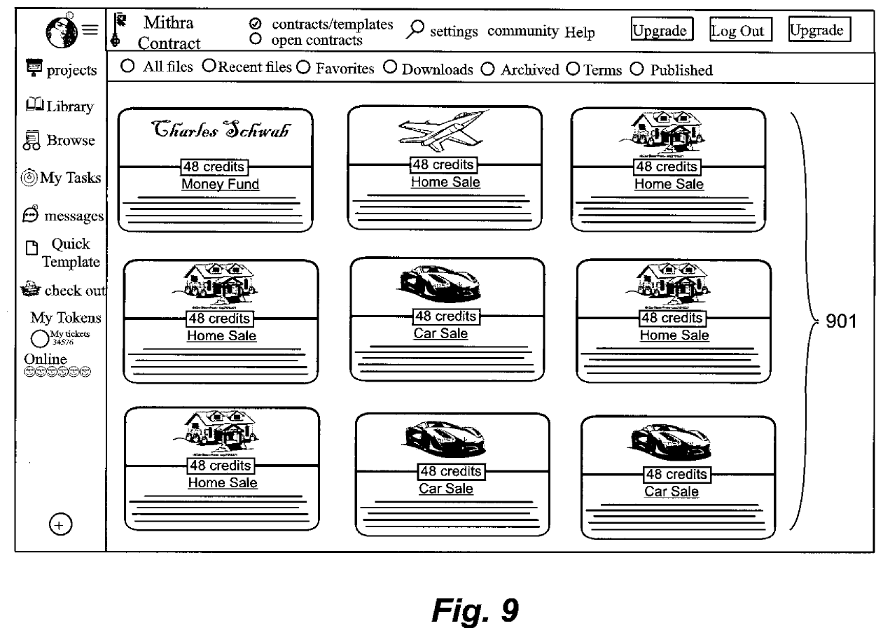

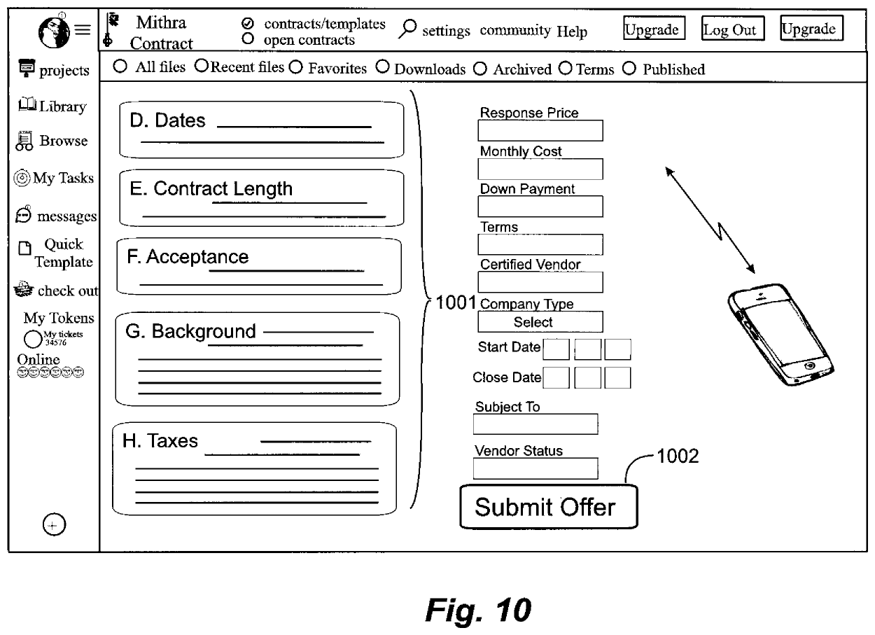

Mithra's public store creates a marketplace for contracts. Referring back to FIG. 5, and the description of FIG. 5 above, the contract marketplace may be searched. This innovative marketplace model allows vendors to list their contracts, as well as interested parties to subscribe to or search for certain types of contracts. For instance, an IT service company that is interested in government contracts can look for any government RFP for IT services; or a property renter who prefers a short-term lease in a particular area can subscribe to alerts whenever such a lease comes to the market. FIG. 9 shows an exemplary result of a search for contracts or a listing by a contract owner. A plurality of contracts is shown with each indicated as annotated icons in FIG. 9.
Upon finding a contract in the contract marketplace, a participant may select a contract to be redirected to a human-readable version 1001 of the contract, as shown in FIG. 10. The participant is enabled to join the contract by submitting an offer or a proposal, e.g., a property offer or a RFC proposal. A submission form is provided alongside of the contract so that each value entered in a field automatically appears on the digital contract. Once all fields are filled in on the submission form, the participant can preview the entire contract displayed on the other side, and then submit the offer by selecting the “SUBMIT” link 1002 at the bottom.
A counter Mithra Token is subsequently generated for the recipient(s) who is now in the contract workflow and can start the negotiation process.

### Negotiating a Contract

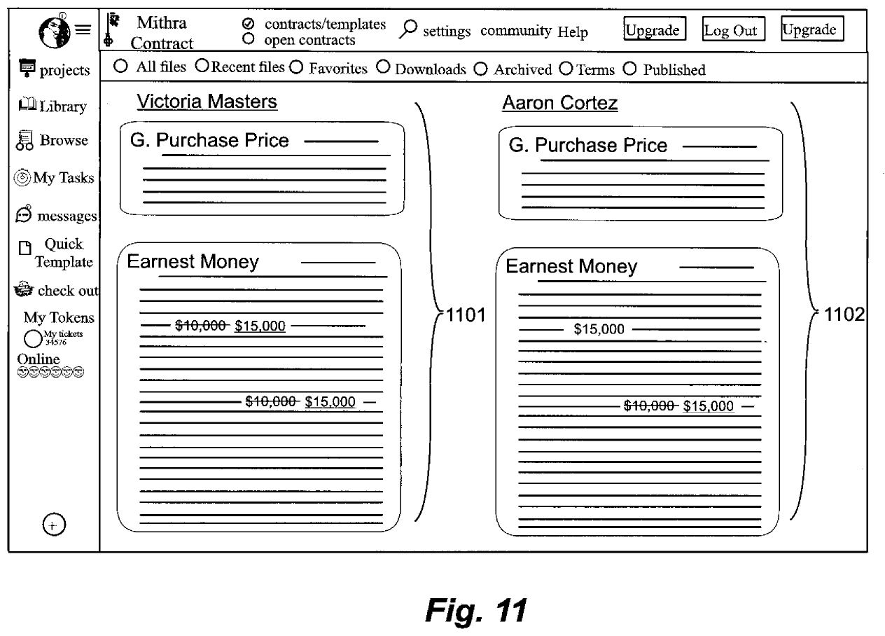

Mithra Contracts, fully digitized and tokenized contracts, give rise to an unprecedented capability in contract negotiation. By holding respective contract terms on a Mithra Token, each party can fully participate in real time contract negotiation and view counter terms as they are presented. With distributed ledger technology, parties can be assured that all the changes are verifiable and tamper-proof. This procedure creates trust among all contract participants. In addition, the system provides a powerful side-by-side review dashboard illustrated as FIG. 11, whereby participants may work together to amend contract terms so that each party can see track changes and has an opportunity to accept changes. In FIG. 11 Victoria has proposed a change in earnest money from $10,000 to $15,000 at two places in the contract, which she does by lining through the $10,000 value and entering the new $15,000 value. In Aaron's version, Aaron has accepted the first of the two changes, but not yet the second.

These changes may involve removing terms, adding terms, or changing variables existing within templates for the terms. When such a change is made, the change may be made to both the human readable versions that are shown in FIG. 11 and the underlying smart contract code.

### Shortlisting—Handling Multiple Offers

In a situation, e.g., an RFC or a property sale, where multiple offers are received from participants, the system allows a contract issuer to shortlist a number of offers so that the issuer can concentrate his negotiation on those selected offers. He will further choose the contract winner by signing the smart contract.

### Signing a Contract—Matching Mithra Tokens

Once all terms are matched between an issuing token and its counter token carried by their respective holders, the smart contract can be signed and executed.

### Transferring Ownership—Transferring Mithra Tokens

A Mithra Token can carry rights and obligations of an asset. Under certain circumstances, the token can be transferred from one party to another so that all the rights and obligations that are inherent within the token would be transferred along. For instance, before closing a property sale, a buyer's financial situation changes suddenly due to loss of job. He can no longer afford to buy the property. However, he is able to find a new buyer who is willing to carry over all rights and obligations, represented by the Mithra Token, held by the buyer. Perhaps requiring the seller's permission, the buyer may be able to simply transfer the token to the new buyer, thus transferring the token ownership.

### Sharing

Due to Mithra Contact being presented in a human readable format via a www representation, this new type of smart contract becomes shareable via a unique and verifiable link. This inventive smart contract link in which a smart contract is represented by a link can now be privately shared within a group of people, or publically shared across social media or a broader network, based on the visibility setting of a contract.

### Search and Match

Mithra Contract architecture has opened a door for contract search and match in a way that has never been done before.

Due to the searchable nature of Mithra Contracts, coupled with the information searchability controlled by contract issuers, a user can now perform a search via searching the open information of Mithra Contract web representation. Mithra Contract issuers will be in full control of their information and will be able to control whether such information should be open, partially open, or completely hidden.

### Permission and Rights Management

Each participant carries permissions and rights at various levels to enable certain operations such as contract edit, review, sign, attach document or transfer token. Rights are divided into two groups:
1. Rights to existing objects—a set of permissions for a user to perform with the created object. This applies to Mithra Contract, Mithra Group, Mithra Token, and condition.
2. Default rights—a set of permissions for a user to act on an object that has not yet been created.
   Each group is divided into:
Rights for a specific user (Account)
Rights for all (Everyone)
   Rights for a specific user (Account) to the created object are configured while creating the object by the user or are set by another user with rights to this action.
   Permissions for all to the created object (Everyone) are configured when an object is created (all false) and changed by the user having the right to do so. They can be adjusted by user actions with this object.
   Default rights are granted by a user with rights to this action on an object not yet created. Thus, it is possible to grant rights for users who will create groups (MGs) in a Mithra Contract, or who will create tokens (MTs) in this Mithra Group, or add Condition to this token.

### Default Rights for a Specific User (Account)

Once a user who has default rights to create any object produces this object, the rights from the Default are copied to the Rights to this object for this user.
In the case when the address of the user to whom we want to grant default rights is not known, Default Rights for All (Everyone) are granted.
Each field in each structure is a specific right to a specific object.
The below example shows permissions for a Mithra Contract Rights Structure
permissions [0] grantRevoke—the right to grant/revoke rights to actions with this MC
permissions [1] viewing—the right to view data in this MC
permissions [2] editMetadata—right to edit metadata in this MC
permissions [3] createMG—right to create MG in this MC
permissions [4] editMGDefaultRights—the right to edit the default rights for MGs created in this MC
permissions [5] deactivateReactivate—right to delete/restore this MC
permissions [6] attachDocument—the right to add documents to this MC

### Grant of Rights.

The user can obtain rights either by creating an object or by being granted rights by another user who is entitled to grant rights.
To grant rights to an object, the initiator of the transaction must himself have the right grantRevoke to this object.
(!) Msg.sender of the transaction can grant only those rights to a specific object that itself possesses. That is, if the initiator of the transaction does not have any right, then he cannot grant rights to other users.

### Chat

In one embodiment, the dashboards provide enabled participants communication channels, record management and/or a simplified method to create a contract.
Participants can chat via three different types of chat methods:
General chat
   This is the default chat setting. Participants use it as a communication channel on topics they wish to communicate, discuss or collaborate.
On the record chat within a contract or transaction
   Participants mutually agree to chat in a room where chat history will become a supporting document or evidence to a particular contract, or a legally binding agreement on its own within a transaction process. In this method, participants involved in a contract or transaction can collaborate via chat to support the process in a more complete way. A participant will be given two additional options after a chat:
   a. attach the chat history as a document to a particular token, or contract or transaction based on where the chat is initiated; or
   b. tokenize the chat history as a Mithra Token. In this option, a requesting party will be prompted to enter metadata and required information to support the creation of a tokenized contract. The requesting party will become an issuing party of the contract. All other participants will be issued their respective counter tokens which require their final e-signature before the smart contract execution.
   Details on how a legal binding agreement chat is illustrated in the section below.
Legally binding agreement chat as the initiation of a new process or transaction
   Participants mutually agree to chat in a room where chat history will become a legally binding contract. In this method, a chat becomes the first step for the creation of a legally binding contract. It gives participants an easy interface for traditionally a cumbersome process.
   In each step of the chat, a participant will be given an option to import a term template via a keyword search and/or other criteria search such as country, region, industry or agreement type. This will ensure the participant is guided by appropriate legal terms as much as the system can enable.
   At the completion of a chat, and at the request of any participants in chat, the recorded chat will be tokenized into a tokenized contract. The requesting party will be prompted to enter metadata and required information to support the creation of a tokenized contract and the integration to the Mithra platform as a Mithra Contract. The requesting party will become an issuing party of the contract. All other participants will be issued their respective counter token.
   All participants will be given the rights to edit terms and further negotiate the contract
   All participants will be required to sign electronically before the final smart contract is executed.

The chat function described above is supported by messaging chat, voice chat and video chat. However, for the legally binding agreement part of the chat, all media must be converted to text.

### Other Functions

The system provides several other important functions to support the contract process.
Manage user roles and responsibilities
Add attachment to a contract
Download to one of the available document types
Create PDF from a digital contract
Save as template

### Common System Capabilities

There are a number of common underlying capabilities shared between Template

Management and Contract Management or Project Management. They are:
Master Data Management
   A master data set is a common data set that can be used across various areas of the system. Master data is not constrained by a template, or a contract, nor a project (transaction).
   For example, industries, regions, user roles, property and agent master data for real estate, institution and health practitioner master data for medical, and university and course master data for education.
Metadata Management
   Metadata is a set of common data that is used for a specific template, a project (transaction), a contract or a set of terms (Mithra Token). Metadata can be either common or industry/subject specific. It is carried across entities within the hierarchy.
   For example, project name, project creation date, project template used, status, visibility flag (public or private) are a common metadata set for a project whereas property data like listing agent ID and property photos could be real estate industry specific project metadata.
   All project-level metadata is shared across contracts and Mithra Tokens within the project. All contract-level metadata is shared across Mithra Tokens within that contract. Metadata in a lower-level hierarchy supersedes that in higher level. For instance, a procurement project has its Visibility Flag (metadata) set to “Yes” at the project level. The project has 10 contracts, of which two of them have the Visibility Flag set to “No”. It means that those two contracts are not visible to the public whereas other eight contracts are available to the public to view or search.
Template Creation
   As described in the previous sections, a template can be created either via Library or via the Project area when a user saves a project template, a contract template or a term template for the first time.
Template Update
   Similar to the template creation function, a template can be updated via a user's Library dashboard or within a project flow where an updated project, contract or term is saved.
Editor
   Editor is used widely across the system. Mithra Contract has an inline editor built in. It is used to create, edit and manage templates, projects, contracts and terms including metadata.
   There are both input editor and output editor in place:
      An example of an input editor is that a user can load terms to a Mithra Token from a binary file like Microsoft Office (.doc, .xls), Office Open XML (.docx, .xlsx) or OpenDocument (.odt, .ods). One of the implementations is that the document is parsed through by numbered lists and headers. Each header or element of numbered list becomes a term. If it is a header then the header text becomes the name of the term and the text that follows the header becomes the value of the term. If there is no text following the header, then the term's value becomes empty. If the header has numeration then it is saved as the term's numeration. Otherwise it is calculated automatically. If it is a numbered list element and it is not a header then the term's name stays empty and only numeration and value is assigned. The type of the header (Header 1, Header 2 etc.) or indent of numeration shows the indent of the terms. Term ends where the next header or numbered element appears. And, depending on its indent, the numeration of the next term is calculated. There is an ability to exclude some headers and numerations from being extracted as terms.
      User can manage a contract or template output, i.e., a printable version, either through a pre-defined output where the user uploads her own PDF form to be used as a template for the output, or a system generated output in which the user can define header, footer, style, font, color and so forth.
Notifications
   Notifications—email, SMS and/or push notifications—are used for alerts such as status change, new invitation, new offer, revised contract and so forth.
Term Search
Global Search
PDF Generation
Publishing
Workflow

### Sharing

Due to Mithra Contracts being presented in a human readable format via a www representation, this new type of smart contract becomes shareable via a unique and verifiable link. This inventive smart contract link in which a smart contract is represented by a link can now be privately shared within a group of people, or publicly shared across social media or a broader network, based on the visibility setting of a contract.

### Example Smart Contract

An example of the definition of the Mithra Contract implementation is presented below.

The skilled person, reading and understanding the many and varied descriptions in this specification will also understand that all of the descriptions of specific embodiments are exemplary, and simply representative of many other descriptions not provided that may fall within the scope of the inventions enabled herein. The scope of the invention is limited only by the claims.

We claim:

1. A system for creating, negotiating, and ratifying smart contracts comprising:
an Internet-connected server executing software (SW) on a processor, the SW providing a web presence with interactive interfaces;
a data repository coupled to the server, storing user information, contract templates, and completed contracts;
a port to a blockchain service;
a registration interface for registering users, each user sat registration issued a digital blockchain wallet; and
a communication service whereby registered users communicate;
wherein a registered user initiates a smart contract either by manually authoring the smart contract by an on-line editor, or by accessing a smart contract template from the data repository, the new contract, submitted to blockchain, being associated with a token defining contract terms of the smart contract, and wherein,
with the issuing token in place, the contract issuer engages one or more counterparties to join the smart contract, a counterparty, by active engagement creating a counter token defining rights and obligations under the smart contract for the counterparty, and wherein, through the communication service the initiator and the counterparties negotiate contract terms to agreement and the smart contract is signed.

2. The system of claim 1 wherein the smart contract is linked to a human-readable representation of the smart contract's contract terms.

3. The system of claim 1 wherein the counterparty is invited to join the smart contract by a direct email or text invitation from the initiator.

4. The system of claim 3 wherein the issuer assigns user permissions to each invited counterparty, including but not limited to administration privileges, view only, edit and/or comment, or sign only.

5. The system of claim 3 wherein, upon receiving the invitation via email or SMS, the invitee signs into the system, or registers, if a first-time user.

6. The system of claim 5 wherein the initiator and a counterparty negotiate contract terms via a chat communication system, with terms codified in the respective tokens.

7. The system of claim 5 wherein the initiator and the counterparty each are provided a human-readable version of the smart contract in a side-by-side presentation, such that each party may propose changes in terms, which may be reviewed and accepted or countered by the other party, until agreement is reached.

8. The system of claim 1 further comprising a search function whereby users may search templates in the data repository to select a template for initiating a contract.

9. The system of claim 1 further comprising a search function whereby a user may search published contracts and join a selected contract by submitting an offer or a proposal.

10. The system of claim 9 wherein, upon a user selecting a contract in a result of a search, a submission form is presented to the user, whereby the user may enter terms, which are entered in the smart contract, and a negotiation is initiated between the issuer and the submitting user.

11. The system of claim 10 wherein the submitting user is issued a counter token defining rights and obligations for that user, who is now admitted to the negotiation process.

12. A method for creating, negotiating, and ratifying smart contracts comprising: initiating a smart contract either by manually authoring by an on-line editor operating by execution of software on a processor of an Internet-connected server, providing a system of interactive interfaces, or by accessing a smart contract template from a data repository coupled to the server; associating the new smart contract with a Mithra token defining all contract terms, by submitting the contract to a blockchain service; engaging a counterparty to join the smart contract, the counterparty issued a counter token defining rights and obligations for the counterparty; negotiating smart contract terms to agreement by the initiator and the counterparty using on-line communication service; and signing and publishing the smart contract to a public store or a private store.

13. The method of claim 12 comprising providing the contract as both human-readable and machine readable.

14. The method of claim 12 comprising inviting a counterparty to join a contract by a direct email or text invitation from the initiator.

15. The method of claim 14 comprising assigning user permissions to each invited counterparty, including but not limited to administration privileges, view only, edit and/or comment, or sign only.

16. The method of claim 14 wherein, upon receiving the invitation via email or SMS, signing into the system or registering by the invitee.

17. The method of claim 16 comprising negotiating contract terms between the initiator and a counterparty via a chat communication system, with terms codified in the respective Mithra tokens.

18. The method of claim 16 comprising providing in an interactive a human-readable version of the smart contract in a side-by-side presentation for the initiator and the counterparty, such that each party may propose changes in terms, which may be reviewed and accepted or countered by the other party, until agreement is reached.

19. The method of claim 11 further comprising a user searching by a search function for templates in the data repository to select a template for initiating a contract.

20. The method of claim 11 further comprising a user searching by a search function for published contracts and joining a selected contract by submitting an offer or a proposal.

21. The method of claim 20 comprising presenting a submission form to a user whereby the user may enter terms, which are entered in the smart contract, and a negotiation is initiated between the issuer and the submitting user.

22. The method of claim 21 comprising issuing a counter Mithra token defining rights and obligations for the submitting user, who is now admitted to the negotiation process.

23. A method for creating a human readable smart contract, comprising: generating a smart contract comprising code in a scripting language, the code specifying terms defining rights and obligations of at least two parties; generating a human readable text describing the terms of the smart contract; and linking a first address that defines a location of the smart contract with a second address that defines a location of the human readable text on the World Wide Web, whereby the linking enables readability of the smart contract.

24. The method of claim 23, further comprising: receiving, from a user, a selection of a template describing at least one term, the template including a fixed part and a variable; and receiving, from the user, a value for the variable, wherein the generating the human readable text comprises generating the code such that the code specifies the at least one term in accordance with the value, and wherein the generating the smart contract comprises generating the human readable text to describe the at least one term in accordance with the value.

25. The method of claim 24, further comprising: receiving, from one of the at least two parties, an edit to the human readable text, the edit altering the value for the variable; and modifying the smart contract to specify the at least one term with the altered value.
